(19) United States
(12) Patent Application Publication
(10) Pub. No.: US 2026/0347551 A1
(43) Pub. Date: Nov. 5, 2026

(54) METHOD FOR PRODUCING LIQUID COMPOSITION

(71) Applicant: AGC INC., Tokyo (JP)

(72) Inventor: Ayaka HOSOYA, Tokyo (JP)

(73) Assignee: AGC INC., Tokyo (JP)

(21) Appl. No.: 19/697,860

(22) Filed: Jun. 4, 2026

Related U.S. Application Data
(63) Continuation of application No. PCT/JP2024/041602, filed on Nov. 25, 2024.

(30) Foreign Application Priority Data
Dec. 5, 2023 (JP) 2023-205520

(51) Int. Cl. C08J 3/09; C08F 8/12; C08F 214/26; C08F 216/14; C08J 3/03; C08J 3/12; C08J 5/22

(52) U.S. Cl. CPC C08J 3/095; C08F 8/12; C08F 214/262; C08F 216/1475; C08J 3/03; C08J 3/12; C08J 5/225; C08J 2327/18; C08J 2329/10

(57) ABSTRACT

To provide a method for producing a liquid composition containing a fluorinated polymer with a small particle size, and being excellent in production consistency. From a mixture obtained by subjecting a fluorinated polymer F having a group convertible to an ion exchange group to a hydrolysis treatment and conversion to acid form to convert the group convertible to an ion exchange group into an acid-form ion exchange group in a first solvent, a solid composition containing a fluorinated polymer H having an ion exchange group and the first solvent is separated; a treatment to remove the first solvent from the solid composition is conducted to obtain a composition having a content of the first solvent relative to the total mass of the fluorinated polymer H of 2 to 200 mass %; and the composition is mixed with a second solvent containing water and an alcohol to obtain a liquid composition containing the fluorinated polymer H having an ion exchange group.

### TECHNICAL FIELD

The present invention relates to a method for producing a liquid composition.

### BACKGROUND ART

A polymer electrolyte fuel cell is formed, for example, by sandwiching a membrane electrode assembly between two separators to form a cell, and stacking a plurality of such cells. The membrane electrode assembly comprises an anode and a cathode, each having a catalyst layer, and a polymer electrolyte membrane disposed between the anode and the cathode.

The polymer electrolyte membrane is formed, for example, by impregnating a reinforcing member with a liquid composition containing a solvent and a fluorinated polymer having an ion exchange group, followed by drying. The catalyst layer in the membrane electrode assembly is formed, for example, by applying a catalyst layer-forming coating liquid obtained by mixing the liquid composition and a catalyst, followed by drying.

The liquid composition is produced, for example, as follows. First, a fluorinated polymer having a group convertible to an ion exchange group, is subjected to a hydrolysis treatment and conversion to acid form, and treatments such as washing with water and drying, to obtain a power of a fluorinated polymer having an ion exchange group. The powder of the fluorinated polymer having an ion exchange group is mixed with a solvent to obtain the above liquid composition (Patent Document 1).

### PRIOR ART DOCUMENTS

### Patent Documents

Patent Document 1: JP-A-2004-035864

### DISCLOSURE OF INVENTION

### Technical Problem

When a reinforcing member (particularly a porous body) is impregnated with the liquid composition in production of the polymer electrolyte membrane, if the particle size of the fluorinated polymer having an ion exchange group in the liquid composition is large, the fluorinated polymer may sometimes hardly penetrate into pores of the porous body. As a result, the fluorinated polymer cannot uniformly infiltrate into the reinforcing member (particularly the porous body), thus causing unfilled pores. The unfilled pores have no proton transport property, whereby the polymer electrolyte membrane tends to have a high proton transport resistance. A membrane electrolyte assembly using a polymer electrolyte membrane with a high proton transport resistance deteriorates the power generation performance of a fuel cell, due to its low proton transport property. Thus, the fluorinated polymer having an ion exchange group, contained in the liquid composition, is required to have a small particle size.

Further, when a plurality of liquid compositions are produced under the same conditions, there may be variations in the concentration of the fluorinated polymer among the plurality of the liquid compositions despite being produced under the same conditions. Therefore, it is required that a plurality of liquid compositions produced under the same conditions have small variations in the concentration of the fluorinated polymer (hereinafter also referred to as being excellent in “production consistency”).

The present inventor has conducted production of the liquid composition by the method as disclosed in Patent Document 1 and as a result found that the fluorinated polymer having an ion exchange group may have a too large particle size or the liquid composition may be inferior in the production consistency, and there is a room for improvement.

Under these circumstances, the present invention has been made to solve the above problems, and it is an object of the present invention to provide a method for producing a liquid composition containing a fluorinated polymer with a small particle size and being excellent in production consistency.

### Solution to Problem

The present inventor has found that the above objects can be achieved by the following configurations.

[1]

A method for producing a liquid composition, which comprises:
separating, from a mixture obtained by subjecting a fluorinated polymer F having a group convertible to an ion exchange group to a hydrolysis treatment and conversion to acid form to convert the group convertible to an ion exchange group into an acid-form ion exchange group in a first solvent, a solid composition containing a fluorinated polymer H having an ion exchange group and the first solvent,
conducting a treatment to remove the first solvent from the solid composition to obtain a composition having a content of the first solvent relative to the total mass of the fluorinated polymer H of 2 to 200 mass %, and
mixing the composition with a second solvent containing water and an alcohol to obtain a liquid composition containing the fluorinated polymer H having an ion exchange group.
   [2]

The method for producing the liquid composition according to [1], wherein the fluorinated polymer F has a unit based on a compound represented by formula (1):

CF₂═CF-L-(A)ₙ Formula (1)
in formula (1), L is a (n+1)-valent perfluorohydrocarbon group which may contain an etheric oxygen atom, A is a group convertible to a sulfonic acid functional group, and
n is 1 or 2.
   [3]

The method for producing the liquid composition according to [1] or [2], wherein the fluorinated polymer H has an ion exchange capacity of 0.8 to 3.0 meq/g dry resin.

[4]

The method for producing the liquid composition according to any one of [1] to [3], wherein the alcohol contains at least one member selected from the group consisting of ethanol, 1-propanol, 1-butanol and 2-propanol.

[5]

The method for producing the liquid composition according to any one of [1] to [4], wherein the liquid composition is used for production of a polymer electrolyte membrane.

[6]

The method for producing the liquid composition according to any one of [1] to [4], wherein the liquid composition is used for production of at least one of a catalyst layer of an anode and a catalyst layer of a cathode in a membrane electrode assembly comprising an anode having a catalyst layer, a cathode having a catalyst layer, and a polymer electrolyte membrane disposed between the anode and the cathode.

[7] The method for producing the liquid composition according to any one of [1] to [6], wherein the content of the second solvent is 50 mass % or more and 95 mass % or less relative to the total mass of the liquid composition.
[8]

The method for producing the liquid composition according to any one of [1] to [6], wherein the fluorinated polymer H is dispersed in the second solvent in the form of particles, and the particles have an average secondary particle size of 1 nm or more and less than 400 nm.

### Advantageous Effects of Invention

According to the present invention, it is possible to provide a method for producing a liquid composition containing a fluorinated polymer with a small particle size and being excellent in production consistency.

### BRIEF DESCRIPTION OF DRAWINGS

FIG. 1 is a cross sectional view illustrating an example of a membrane electrode assembly.

FIG. 2 is a cross sectional view illustrating an example of a membrane electrode assembly.

### DESCRIPTION OF EMBODIMENTS

The following definitions of terms apply throughout the specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may, for example, be (—SO₃⁻)Ma⁺, (—SO₃⁻)₂Mb²⁺ or (—SO₃⁻)₃Mc³⁺ (where Mat is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may, for example, be (—COO⁻)Ma⁺, (—COO⁻)₂Mb²⁺ or (—COO⁻)₃Mc³⁺ (where Mat is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “group convertible to an ion exchange group” refers to a group that can be converted to an ion exchange group by treatments such as a hydrolysis treatment and conversion to acid form, and will also be referred to as a “precursor group”

A “group convertible to a sulfonic acid functional group” refers to a group that can be converted to a sulfonic acid functional group by treatments such as a hydrolysis treatment and conversion to acid form.

A “group convertible to a carboxylic acid functional group” refers to a group that can be converted to a carboxylic acid functional group by known treatments such as a hydrolysis treatment and conversion to acid form.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure. In the following, in some cases, a unit derived from a certain monomer will be represented by the monomer name, followed by “unit”.

“to” used to show a range of numerical values is used to include numerical values before and after it as the lower limit value and the upper limit value. In numerical ranges described stepwise in this specification, the upper limit value or the lower limit value described in a certain numerical range may be replaced with an upper limit value or a lower limit value of another numerical range described stepwise. In numerical ranges described in this specification, the upper limit value or the lower limit value described in a certain numerical range may be replaced with values indicated in Examples.

### [Method for Producing Liquid Composition]

The method for producing a liquid composition of the present invention (hereinafter also referred to as “the present production method”) comprises
step 1 of separating, from a mixture obtained by subjecting a fluorinated polymer having a group convertible to an ion exchange group to a hydrolysis treatment and conversion to acid form to convert the group convertible to an ion exchange group into an acid-form ion exchange group in a first solvent, a solid composition containing a fluorinated polymer having an ion exchange group and the first solvent,
step 2 of conducting a treatment to remove the first solvent from the solid composition to obtain a composition having a content of the first solvent relative to the total mass of the fluorinated polymer of 2 to 200 mass %, and
step 3 of mixing the composition with a second solvent containing water and an alcohol to obtain a liquid composition containing the fluorinated polymer having an ion exchange group.

In the following description, unless otherwise specified, a “fluorinated polymer having a group convertible to an ion exchange group” will be referred to as “polymer F”, and a “fluorinated polymer having an ion exchange group” will be referred to as “polymer H”.

According to the present production method, a liquid composition containing a polymer H with a small particle size and being excellent in production consistency will be obtained.

It is estimated as follows. That is, when a treatment of removing the first solvent from the solid composition obtained in step 1 is conducted, by adjusting the content of the first solvent in the obtainable composition to be 2 mass % or more relative to the total mass of the polymer H, excessive agglomeration of the particles containing the polymer H is suppressed and as a result, the particle size of the particles containing the polymer H in the liquid composition can be reduced.

Further, it is estimated that when the treatment of removing the first solvent from the solid composition obtained in step 1 is conducted, by adjusting the content of the first solvent in the obtainable composition to be 200 mass % or less relative to the total mass of the polymer H, the dispersion of the amount of the first solvent contained in the polymer H is suppressed, whereby the liquid composition excellent in the production consistency is obtained.

### <Step 1>

Step 1 is a step of separating, from a mixture obtained by subjecting the polymer F to a hydrolysis treatment and conversion to acid form to convert the group convertible to an ion exchange group into an acid-form ion exchange group in a first solvent, a solid composition containing a polymer H and the first solvent,

### <Polymer F>

The polymer F is not particularly limited so long as it is a polymer having a fluorine atom and having a group convertible to an ion exchange group, and in view of more excellent effects of the present invention, preferred is the following polymer F-1 or polymer F-2.

### (Polymer F-1)

The polymer F-1 is a copolymer having a unit based on a fluorinated olefin and a unit based on a fluorinated monomer having a group convertible to an ion exchange group, and is preferably a copolymer having a unit based on a fluorinated olefin (preferably tetrafluoroethylene) and a unit based on a fluorinated monomer having a group convertible to a sulfonic acid functional group (preferably a compound represented by formula (1) to be described below).

The polymer F-1 preferably has no cyclic ether structure.

The fluorinated olefin may, for example, be a C₂₋₃ fluoroolefin having one or more fluorine atoms in its molecule. Specific examples of the fluoroolefin include tetrafluoroethylene (hereinafter also referred to as “TFE”), chlorotrifluoroethylene, vinylidene fluoride, vinyl fluoride, and hexafluoropropylene. Among them, preferred is TFE, in view of monomer production cost, reactivity with other monomer, and excellent properties of the obtainable polymer F-1.

The fluorinated olefin may be used alone or in combination of two or more.

The content of the unit based on the fluorinated olefin relative to all units of the polymer F-1 is preferably 11 mass % or more, more preferably 38 mass % or more, and is preferably 59 mass % or less, more preferably 55 mass % or less.

The fluorinated monomer having a group convertible to an ion exchange group may be a compound having one or more fluorine atoms in its molecule, having an ethylenic double bond, and having a group convertible to a sulfonic acid functional group.

The fluorinated monomer having a group convertible to an ion exchange group is, in view of the monomer production cost, reactivity with other monomer and excellent properties of the obtainable polymer F-1, preferably a compound represented by formula (1).

CF₂═CF-L-(A)ₙ Formula (1)

L is a (n+1)-valent perfluorohydrocarbon group which may contain an etheric oxygen atom.

The etheric oxygen atom may be present at a terminal end of the perfluorohydrocarbon group or may be present between carbon atoms.

The number of carbon atoms in the (n+1)-valent perfluorohydrocarbon group is preferably one or more, preferably two or more, and is preferably 20 or less, more preferably 10 or less.

L is preferably a (n+1)-valent perfluoroaliphatic hydrocarbon group which may contain an etheric oxygen atom, and is more preferably a bivalent perfluoroalkylene group which may contain an etheric oxygen atom corresponding to an embodiment of n=1, or a trivalent perfluoroaliphatic hydrocarbon group which may contain an etheric oxygen atom corresponding to an embodiment of n=2.

The bivalent perfluoroalkylene group may be either linear or branched.

A is a group convertible to a sulfonic acid functional group. The group convertible to a sulfonic acid functional group is preferably a functional group convertible to a sulfonic acid functional group by hydrolysis. Specific examples of the group convertible to a sulfonic acid functional group include −SO₂F, —SO₂Cl and —SO₂Br.

n is 1 or 2.

The compound represented by formula (1) is preferably a compound represented by formula (1-1), a compound represented by formula (1-2), a compound represented by formula (1-3) or a compound represented by formula (1-4).

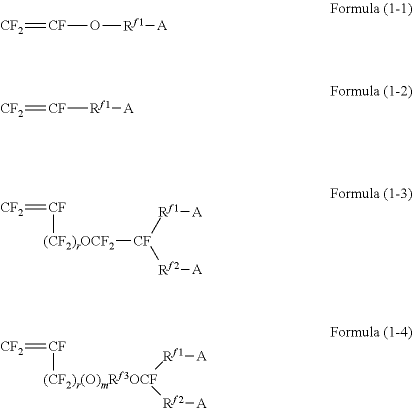

R^{f1} is a perfluoroalkylene group which may contain an oxygen atom between carbon atoms. The number of carbon atoms of the perfluoroalkylene group is preferably 1 or more, more preferably 2 or more, and is preferably 20 or less, more preferably 10 or less.

R^{f2} is a single bond or a perfluoroalkylene group which may contain an oxygen atom between carbon atoms. The number of carbon atoms in the perfluoroalkylene group is preferably one or more, more preferably two or more, and is preferably 20 or less, more preferably 10 or less.

R^{f3} is a single bond or a perfluoroalkylene group which may contain an oxygen atom between carbon atoms. The number of carbon atoms in the perfluoroalkylene group is preferably one or more, more preferably two or more, and is preferably 20 or less, more preferably 10 or less.

r is 0 or 1.

m is 0 or 1.

A in the formulae is as defied above.

The compound represented by formula (1-1) and the compound represented by formula (1-2) are preferably a compound represented by formula (1-5).

CF₂═CF—(CF₂)ₓ—(OCF₂CFY)_{y}—O—(CF₂)_{z}—SO₃F Formula (1-5)
x is 0 or 1, y is an integer of 0 to 2, z is an integer of 1 to 4, and Y is F or CF₃.

Specific examples of the compound represented by formula (1-1) include the following compounds. In formulae, w is an integer of 1 to 8, and x is an integer of 1 to 5.

CF₂═CF—O—(CF₂)_{w}—SO₂F

CF₂═CF—O—CF₂CF(CF₃)—O—(CF₂)_{w}—SO₂F

CF₂═CF—[O—CF₂CF(CF₃)]ₓ—SO₂F

Specific examples of the compound represented by formula (1-2) include the following compounds. In the formulae, w is an integer of 1 to 8.

CF₂═CF—(CF₂)_{w}—SO₂F

CF₂═CF—CF₂—O—(CF₂)_{w}—SO₂F

The compound represented by formula (1-3) is preferably a compound represented by formula (1-3-1).

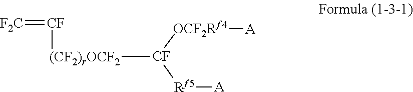

R^{f4} is a C₁₋₆ linear perfluoroalkylene group, and R^{f5} is a single bond or a C₁₋₆ linear perfluoroalkylene group which may contain an oxygen atom between carbon atoms. r and A are as defined above.

Specific examples of the compound represented by formula (1-3-1) are as follows.

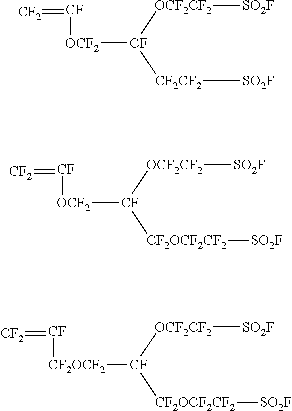

The compound represented by formula (1-4) is preferably a compound represented by formula (1-4-1).

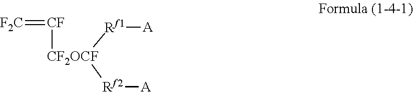

In the formulae, R^{f1}, R^{f2} and A are as defined above.

Specific examples of the compound represented by formula (1-4-1) are as follows.

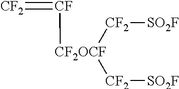

The fluorinated monomer having a group convertible to an ion exchange group may be used alone or in combination of two or more.

The content of the unit based on the fluorinated monomer having a group convertible to an ion exchange group, relative to all units of the polymer F-1, is preferably 41 mass % or more, more preferably 45 mass % or more, and is preferably 89 mass % or less, more preferably 62 mass % or less.

For production of the polymer F-1, a monomer other than the above monomers (hereinafter also referred to as “other monomer”) may be used.

Specific examples of the other monomer include CF₂═CFR^{f6} (wherein R^{f6} is a C₂₋₁₀ perfluoroalkyl group), CF₂═CF—OR^{f7} (wherein R¹⁷ is a C₁₋₁₀ perfluoroalkyl group), and CF₂═CFO (CF₂)ᵥCF═CF₂ (wherein v is an integer of 1 to 3).

The content of the unit based on the other monomer is preferably 30 mass % or less relative to all units of the polymer F-1 with a view to maintaining the ion exchange performance.

### (Polymer F-2)

The polymer F-2 is a fluorinated polymer having a unit based on a monomer having a cyclic ether structure and having a group convertible to an ion exchange group, and is preferably a copolymer having a unit based on a monomer having a cyclic ether structure and a unit based on a fluorinated monomer having a group convertible to an ion exchange group.

Specific examples of the monomer having a cyclic ether structure include monomer m11, monomer m12, monomer m21 and monomer m22.

The monomer m11 is a monomer represented by formula (m11), and a preferred embodiment of the monomer m11 may be formula (m11-1).

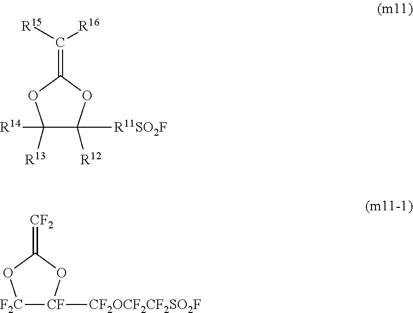

R¹¹ is a bivalent perfluoroalkylene group which may have an etheric oxygen atom. In a case where the perfluoroalkylene group has an etheric oxygen atom, the number of the oxygen atom may be one or more. The oxygen atom may be present in a carbon-carbon bond or at a terminal end of the carbon atom bond of the perfluoroalkylene group. The perfluoroalkylene group may be linear or branched and is preferably linear.

R¹², R¹³, R¹⁵ and R¹⁶ are each independently a fluorine atom or a monovalent perfluoroalkyl group which may have an etheric oxygen atom. In view of high polymerizability, it is preferred that at least one of R¹⁵ and R¹⁶ is a fluorine atom, and it is more preferred that both of them are a fluorine atom.

R¹⁴ is a monovalent perfluoroalkyl group which may contain an etheric oxygen atom, a fluorine atom, or a group represented by R¹¹SO₂F. In a case where the perfluoroalkyl group has an etheric oxygen atom, the number of the oxygen atom may be one or more. The oxygen atom may be present in a carbon-carbon bond or at a terminal end of the carbon atom bond of the perfluoroalkyl group. The perfluoroalkyl group may be linear or branched and is preferably linear. In a case where the compound of formula (m11) has two R¹¹'s, the two R¹¹'s may be the same or different from each other.

The monomer m12 is a monomer represented by formula (m12), and preferred embodiments of the monomer m 12 include formulae (m12-1) and (m12-2).

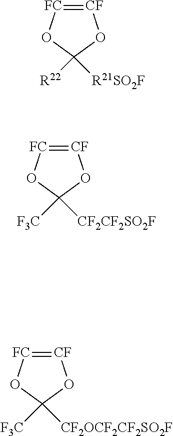

R²¹ is a C₁₋₆ perfluoroalkylene group or a C₂₋₆ perfluoroalkylene group having an etheric oxygen atom in a carbon-carbon bond. In a case where the perfluoroalkylene group has an etheric oxygen atom, the number of the oxygen atom may be one or more. The perfluoroalkylene group may be linear or branched and is preferably linear.

R²² is a fluorine atom, a C₁₋₆ perfluoroalkyl group, a C₂₋₆ perfluoroalkyl group having an etheric oxygen atom in a carbon-carbon bond, or a group represented by R²¹SO₂F. in a case where the perfluoroalkyl group has an etheric oxygen atom, the number of the oxygen atom may be one or more. The perfluoroalkyl group may be linear or branched and is preferably linear. In a case where formula (m12) has two R²¹'s, the two R²¹'s may be the same or different.

The monomer m21 is a monomer represented by formula (m21), and a preferred embodiment of the monomer m21 includes formula (m21-1).

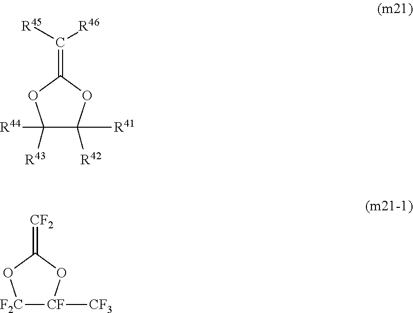

R⁴¹, R⁴², R⁴³, R⁴⁴, R⁴⁵ and R⁴⁶ are each independently a fluorine atom or a monovalent perfluoroalkyl group which may have an etheric oxygen atom. In a case where the perfluoroalkyl group has an etheric oxygen atom, the number of the oxygen atom may be one or more. The oxygen atom may be present in a carbon-carbon bond or at a terminal end of a carbon atom bond. The perfluoroalkyl group may be linear or branched and is preferably linear.

In view of high polymerizability, it is preferred that at least one of R⁴⁵ and R⁴⁶ is a fluorine atom, and it is more preferred that both are fluorine atoms.

The monomer m22 is a monomer represented by formula (m22), and a preferred embodiment of the monomer m22 includes formula (m22-1).

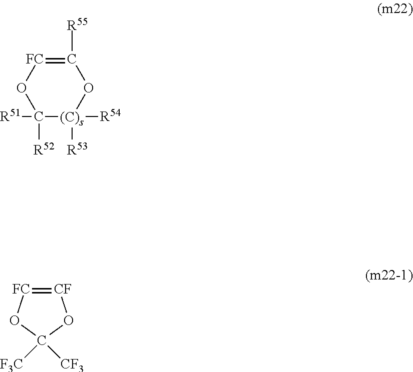

s is 0 or 1 and is preferably 0.

R⁵¹ and R⁵² are each independently a fluorine atom or a C₁₋₅ perfluoroalkyl group, or, both are mutually bonded to form a spiro ring (provided that s is 0).

R⁵³ and R⁵⁴ are each independently a fluorine atom or a C₁₋₅ perfluoroalkyl group.

R⁵⁵ is a fluorine atom, a C₁₋₅ perfluoroalkyl group, or a C₁₋₅ perfluoroalkoxy group. R⁵⁵ is preferably a fluorine atom in view of high polymerizability.

The perfluoroalkyl group and the perfluoroalkoxy group may be linear or branched, and is preferably linear.

The content of the unit based on a monomer having a cyclic ether structure relative to all units of the polymer F-2 is preferably 30 mass % or more, more preferably 48 mass % or more, and is preferably 70 mass % or less, more preferably 63 mass % or less.

Specific examples of the fluorinated monomer having a group convertible to an ion exchange group are the same as those of the fluorinated monomer having a group convertible to an ion exchange group in the polymer F-1.

The content of the unit based on the fluorinated monomer having a group convertible to an ion exchange group, relative to all units of the polymer F-2, is preferably 20 mass % or more, more preferably 28 mass % or more, and is preferably 60 mass % or less, more preferably 50 mass % or less.

The polymer F-2 may have unit based on a fluorinated olefin. Specific examples of the fluorinated olefin are the same as those of the fluorinated olefin in the polymer F-1.

The content of the unit based on the fluorinated olefin (particularly TFE) relative to all units of the polymer F-2 is preferably 0 mass % or more, more preferably 1 mass % or more, and is preferably 20 mass % or less, more preferably 10 mass % or less.

### (Physical Properties of Polymer F)

The TQ value of the polymer F is preferably 100 °C or higher, more preferably 120 °C or higher, further preferably 150 °C or higher, and is preferably 330 °C or lower, more preferably 300 °C or lower, further preferably 300 °C or lower.

The TQ value is a value relating to the molecular weight of the polymer and is a value expressed by a temperature at which the volumetric flow rate becomes 100 mm³/sec.

The TQ value of the polymer F is obtained by the method in EXAMPLES to be described below.

### (Method for Producing Polymer F)

As the method for producing the polymer F, any polymerization method such as bulk polymerization, solution polymerization, suspension polymerization or emulsion polymerization may be employed. Polymerization in liquid or supercritical carbon dioxide may also be conducted.

The polymerization may be conducted under conditions where radicals are generated. As a method of generating radicals, a method of irradiation with radiation such as ultraviolet rays, y rays or electron rays, or a method of adding a radical initiator may be mentioned.

In the method for producing the polymer F, the polymer F is recovered preferably as separated from unreacted monomers, the polymerization solvent, and the like.

The recovered polymer F may be subjected to a heat treatment at 200 °C to 300 °C for 3 to 40 hours. By the heat treatment, the unreacted monomers, the polymerization solvent, and the like can be removed.

The polymer F may be in the form of pellets or may be in the form of a powder.

As a method of obtaining the polymer F in the form of pellets, a method of obtaining a strand containing the polymer F by a melt extruder and cutting the strand to obtain pellets may be mentioned.

As a method of obtaining the polymer F in the form of a powder, a method of pulverizing the polymer F by a known pulverizing machine may be mentioned. The pulverization method is preferably freeze-pulverization.

With a view to suppressing clogging in a case where filtration is conducted in the hydrolysis treatment or conversion to acid form to be described below, the particle size of the polymer F is preferably 0.1 mm or more, more preferably 0.2 mm or more.

In view of excellent reaction efficiency of the precursor group in the hydrolysis treatment or conversion to acid form to be described below, the particle size of the polymer F is preferably 5 mm or less, more preferably 3 mm or less.

The particle size of the polymer F is a value calculated from the particle size distribution measured by mechanical sieving using test sieves of stainless steel (JIS-Z8801).

### <Polymer H>

The polymer H is a polymer obtained by subjecting the polymer F to the hydrolysis treatment and conversion to acid form to convert the group convertible to an ion exchange group in into an acid-form ion exchange group.

The polymer H is not particularly limited so long as it is a polymer having a fluorine atom and having an ion exchange group, and in view of more excellent effects of the present invention, preferably a polymer H-1 or H-2 to be described below.

### (Polymer H-1)

The polymer H-1 is a polymer obtained by converting the group convertible to an ion exchange group in the above polymer F-1 to an ion exchange group.

The polymer H-1 is a copolymer having a unit based on a fluorinated olefin and a unit based on a fluorinated monomer having an ion exchange group, and is more preferably a copolymer having a unit based on a fluorinated olefin (preferably tetrafluoroethylene) and a unit based on a fluorinated monomer having a sulfonic acid functional group (preferably a compound represented by formula (2) to be described below).

The polymer H-1 preferably has no cyclic ether structure.

Specific examples of the unit based on the fluorinated olefin are the same as the specific examples of the unit based on the fluorinated olefin in the polymer F-1.

The content of the unit based on the fluorinated olefin relative to all units of the polymer H-1 is the same as the content of the unit based on the fluorinated olefin relative to all units of the polymer F-1.

The unit based on the fluorinated monomer having an ion exchange group is preferably a unit based on the fluorinated monomer having a sulfonic acid functional group, is more preferably a unit represented by formula (2).

—[CF₂—CF(-L-(SO₃M)ₙ)]- Formula (2)

In formula (2), definitions of L and n are the same as the definitions of L and n in formula (1).

M is a hydrogen atom, an alkali metal or a quaternary ammonium cation.

The unit represented by formula (2) is preferably a unit represented by formula (2-1), a unit represented by formula (2-2), a unit represented by formula (2-3) or a unit represented by formula (2-4).

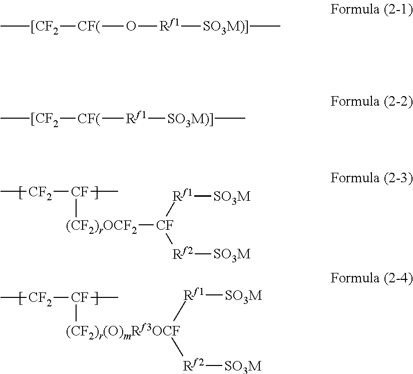

In formulae (2-1) to (2-4), definitions of R^{f1}, R^{f2}, R^{f3}, r and m are the same as definitions of R^{f1}, R^{f2}, R^{f3}, r and m in formulae (1-1) to (1-4).

In the formulae, M is as defined above.

The unit represented by formula (2-1) and the unit represented by formula (2-2) are more preferably a unit represented by formula (2-5).

—[CF₂—CF(—(CF₂)ₓ—(OCF₂CFY)_{y}—O—(CF₂)_{z}—SO₃M)]- Formula (2-5)

In formula (2-5), definitions of x, y, z and Y are the same as the definitions of x, y, z and Y in formula (1-5).

M is as defined above.

Specific examples of the unit represented by formula (2-1) are the following units. In the formulae, w is an integer of 1 to 8, and x is an integer of 1 to 5. In the formulae, M is as defined above.

—[CF₂—CF(—O—(CF₂)_{w}—SO₃M)]-

—[CF₂—CF(—O—CF₂CF(CF₃)—O—(CF₂)_{w}—SO₃M)]-

—[CF₂—CF(—(O—CF₂CF(CF₃)ₓ—SO₃M)]-

Specific examples of the unit represented by formula (2-2) are the following units. In the formulae, w is an integer of 1 to 8. In the formulae, M is as defined above.

[CF₂—CF(—(CF₂)_{w}—SO₃M)]-

—[CF₂—CF(—CF₂—O—(CF₂)_{w}—SO₃M)]-

The units represented by formula (2-3) is preferably a unit represented by formula (2-3-1). In the formulae, M is as defined above.

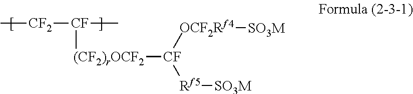

In formula (2-3-1), the definitions of R^{f4} and R^{f5} are the same as the definitions of R^{f4} and R^{f5} in formula (1-3-1). r and M are as defined above.

Specific examples of the unit represented by formula (2-3-1) are as follows.

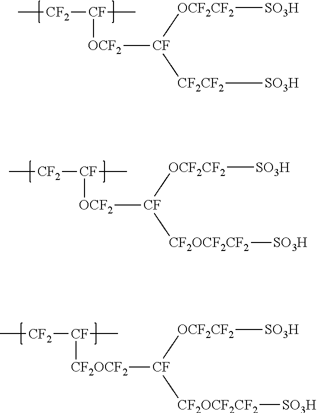

The unit represented by formula (2-4) is preferably a unit represented by formula (2-4-1). In the formula, R^{f1}, R^{f2} and M are as defined above.

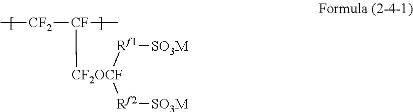

A specific example of the unit represented by formula (2-4-1) is as follows.

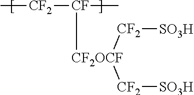

The unit based on the fluorinated monomer having an ion exchange group may be used alone or in combination of two or more.

The content of the unit based on the fluorinated monomer having an ion exchange group in the polymer H-1 is the same as the content of the unit based on the fluorinated monomer having a group convertible to an ion exchange group in the polymer F-1.

The polymer H-1 may contain the unit based on the other monomer as described for the polymer F-1.

The content of the unit based on the other monomer in the polymer H-1 is the same as the content of the unit based on the other monomer in the polymer F-1.

### (Polymer H-2)

The polymer H-2 is a polymer obtained by converting the group convertible to an ion exchange group in the polymer F-2 to an ion exchange group.

The polymer H-2 is a fluorinated polymer having a unit based on a monomer having a cyclic ether structure and having an ion exchange group, and is preferably a copolymer having a unit based on a monomer having a cyclic ether structure and a unit based on a fluorinated monomer having an ion exchange group.

Specific examples of the unit based on the monomer having a cyclic ether structure include unit (u11), unit (u12), unit (u21) and unit (u22).

Unit (u11) is a unit based on the monomer m11, and as a preferred embodiment, unit (u11-1) may be mentioned.

Unit (u12) is a unit based on the monomer m12, and as a preferred embodiment, unit (u12-1) and unit (u12-2) may be mentioned.

Unit (u21) is a unit based on the monomer m21, and as a preferred embodiment, unit (u21-1) may be mentioned.

Unit (u22) is a unit based on the monomer m22, and as a preferred embodiment, unit (u22-1) may be mentioned.

The groups in the formulae are as defined above.

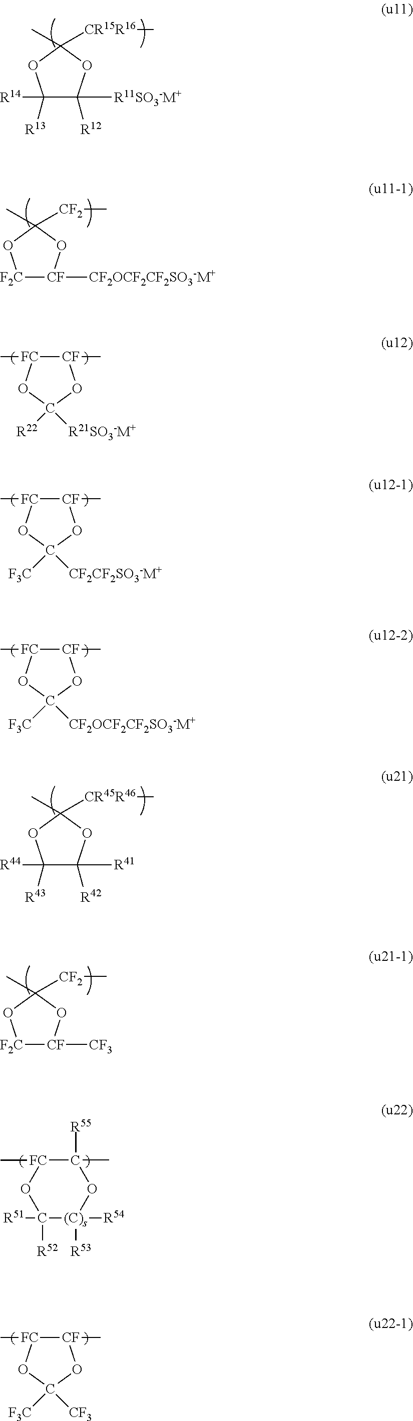

The content of the unit based on the monomer having a cyclic ether structure relative to all units of the polymer H-2 is the same as the content of the unit based on the monomer having a cyclic ether structure relative to all units of the polymer F-2.

Specific examples of the unit based on the fluorinated monomer having an ion exchange group are the same as those of the fluorinated monomer having an ion exchange group in the polymer H-1.

The content of the unit based on the fluorinated monomer having an ion exchange group relative to all units of the polymer H-2 is the same as the content of the unit based on the fluorinated monomer having a group convertible to an ion exchange group relative to all units of the polymer F-2.

The polymer H-2 may have a unit based on a fluorinated olefin. Specific examples of the fluorinated olefin are the same as those of the fluorinated olefin in the polymer H-1.

The content of the unit based on the fluorinated olefin (particularly TFE) relative to all units of the polymer H-2 is the same as the content of the unit based on the fluorinated olefin (particularly TFE) relative to all units of the polymer F-2.

### (Physical Properties of Polymer H)

The ion exchange capacity of the polymer H is, with a view to increasing the proton conductivity and obtaining a sufficient cell output, preferably 0.5 meq/g dry resin or more, more preferably 0.8 meq/g dry resin, further preferably 0.9 meq/g dry resin or more.

The ion exchange capacity of the polymer H is, with a view to increasing the molecular weight of the polymer H and with a view to suppressing excessive swelling by water and thereby keeping mechanical strength, preferably 3.0 meq/g dry resin or less, more preferably 2.2 meq/g dry resin or less, further preferably 2.0 meq/g dry resin or less.

The ion exchange capacity of the polymer H is obtained by the method in Examples to be described below.

### <Treatments in Step 1>

The polymer H is produced by subjecting the polymer F to a hydrolysis treatment and conversion to acid form in the first solvent to convert the group convertible to an ion exchange group (precursor group) in the polymer F into an acid-form ion exchange group.

The first solvent generically refers to a solvent used for production of the polymer H. Specifically, the solvent in the aqueous alkali solution used in the hydrolysis treatment, water in the aqueous acidic solution used in the conversion to acid form, water used in the water-washing treatment, etc., correspond to the first solvent.

In the following, an example of a preferred embodiment of the method for producing the polymer H will be described with reference to an example in which a polymer F having a fluorosulfonyl group (—SO₂F) as a precursor group is used to obtain a polymer H having a sulfonic acid group (—SO₃⁻H⁺) as an ion exchange group.

### (Hydrolysis Treatment)

The hydrolysis treatment is conducted, for example, by bringing the polymer F and an aqueous alkali solution into contact with each other. By this treatment, the fluorosulfonyl group of the polymer F is converted into a sulfonate thereby to obtain a fluorinated polymer having a sulfonate.

The aqueous alkali solution preferably contains a solvent and a basic compound.

The solvent contained in the aqueous alkali solution may, for example, be water or a solvent mixture of water and a polar solvent. Specific examples of the polar solvent include an alcohol (methanol, ethanol and the like) and dimethyl sulfoxide. In particular, the solvent contained in the aqueous alkali solution is preferably a solvent mixture of water and a polar solvent.

In a case where the solvent contained in the aqueous alkali solution is the solvent mixture, the content of the polar solvent relative to the total mass of the solvent mixture is, with a view to improving the reaction rate, preferably 10 mass % or more, more preferably 15 mass % or more, and with a view to suppressing elution of the polymer, preferably 50 mass % or less, more preferably 40 mass % or less.

Specific examples of the basic compound include sodium hydroxide and potassium hydroxide.

The content of the basic compound relative to the total mass of the aqueous alkali solution is, with a view to improving the reaction rate, preferably 10 mass % or more, more preferably 15 mass % or more, and is preferably 50 mass % or less, further preferably 40 mass % or less.

The amount of the aqueous alkali solution used, relative to the amount (100 parts by mass) of the polymer F used, is, in view of the reaction efficiency, preferably 200 parts by mass or more, more preferably 300 parts by mass or more, and with a view to reducing the waste liquid, preferably 1000 parts by mass or less, more preferably 500 parts by mass or less.

The temperature of the aqueous alkali solution is, with a view to improving the reaction rate, preferably 60 °C or higher, more preferably 80 °C or higher, and with a view to suppressing elution of the polymer, preferably 120 °C or lower, more preferably 100 °C or lower.

The contact time (reaction time) of the polymer F and the aqueous alkali solution is, in view of sufficient progress of the reaction, preferably 12 hours or longer, more preferably 16 hours or longer, and with a view to suppressing elution of the polymer, preferably 200 hours or shorter, more preferably 100 hours or shorter.

### (Water Washing Treatment 1)

The method for producing the polymer H preferably has water washing treatment 1 of washing with water the fluorinated polymer after the hydrolysis treatment (fluorinated polymer having a sulfonate).

In the water washing treatment 1, the amount of the water used, relative to the amount (100 parts by mass) of the fluorinated polymer having a sulfonate used is, in view of washing efficiency, preferably 100 parts by mass or more, more preferably 200 parts by mass or more, and with a view to reducing the waste liquid, preferably 1000 parts by mass or less, more preferably 500 parts by mass or less.

In the water washing treatment 1, the water temperature is, in view of washing efficiency, preferably 10 °C or higher, more preferably 20 °C or higher, and with a view to suppressing elution of the polymer, preferably 120 °C or lower, more preferably 100 °C or lower.

In the water washing treatment 1, the washing time is, with a view to improving the washing efficiency, preferably 20 minutes or longer, more preferably 30 minutes or longer, and with a view to suppressing elution of the polymer, preferably 2 hours or shorter, more preferably 1 hour or shorter. The washing time refers to a washing time for each washing operation.

The water washing treatment 1 may be conducted only once, or may be conducted several times. Particularly, the number of the water washing treatment 1 is, with a view to improving the washing efficiency, preferably twice or more, more preferably three times or more, and with a view to suppressing elution of the polymer, preferably 30 times or less, more preferably 20 times or less.

### (Conversion to Acid Form)

The conversion to acid form may be conducted, for example, by bringing the fluorinated polymer after the hydrolysis treatment (fluorinated polymer having a sulfonate) and an aqueous acidic solution into contact with each other, whereby the sulfonate is converted into a sulfonic acid group thereby to obtain the polymer H.

The aqueous acidic solution contains an acid component and water.

Specific examples of the acid component include sulfuric acid and hydrochloric acid.

The content of the acid component relative to the total mass of the aqueous acidic solution is, with a view to improving the reaction rate, preferably 5 mass % or more, more preferably 8 mass % or more, and in view of the handling efficiency of the aqueous acidic solution, preferably 30 mass % or less, more preferably 25 mass % or less.

The amount of the aqueous acidic solution used, relative to the amount (100 parts by mass) of the fluorinated polymer having a sulfonate used, is, in view of the reaction efficiency, preferably 100 parts by mass or more, more preferably 200 parts by mass or more, and with a view to reducing the waste liquid, preferably 1000 parts by mass or less, more preferably 500 parts by mass or less.

The temperature of the aqueous acidic solution is, with a view to improving the reaction rate, preferably 40 °C or higher, more preferably 50 °C or higher, and with a view to suppressing elution of the polymer, preferably 100 °C or lower, more preferably 80 °C or lower.

The contact time (reaction time) of the fluorinated polymer having a sulfonate and the aqueous acidic solution is, in view of sufficient progress of the reaction, preferably 10 minutes or longer, more preferably 20 minutes or longer, and with a view to suppressing elution of the polymer, preferably 2 hours or shorter, more preferably 1 hour or shorter. The contact time refers to a contact time for each operation of the conversion to acid form.

The operation of conversion to acid form may be conducted only once, or may be conducted several times. The number the operation of the conversion to acid form is, in view of sufficient progress of the reaction, preferably twice or more, more preferably three times or more, and with a view to suppressing elution of the polymer, more preferably 40 times or less, more preferably 30 times or less.

### (Water Washing Treatment 2)

The method for producing the polymer H preferably has water washing treatment 2 of washing the fluorinated polymer (polymer H) after the conversion to acid form with water.

In the water washing treatment 2, the amount of the water used, relative to the amount (100 parts by mass) of the polymer H used, is, in view of washing efficiency, preferably 100 parts by mass or more, more preferably 200 parts by mass or more, and with a view to reducing the waste liquid, preferably 1000 parts by mass or less, more preferably 500 parts by mass or less.

In the water washing treatment 2, the water temperature is, in view of washing efficiency, preferably 10 °C or higher, more preferably 20 °C or higher, and with a view to suppressing elution of the polymer, preferably 120 °C or lower, more preferably 100 °C or lower.

In the water washing treatment 2, the water washing time is, with a view to improving the washing efficiency, preferably 10 minutes or longer, more preferably 20 minutes or longer, and with a view to suppressing elution of the polymer, preferably 2 hours or shorter, more preferably 1 hour or shorter. The washing time refers to a washing time for each washing operation.

The water washing treatment 2 may be conducted only once or may be conducted several times. Particularly, the number of the water washing treatment 2 is, with a view to improving the washing efficiency, preferably twice or more, more preferably three times or more, and with a view to suppressing elution of the polymer, preferably 40 times or less, more preferably 30 times or less.

In a case where the operation of the conversion to acid form is conducted several times, the water washing treatment 2 may be conducted between the respective operations of the conversion to acid form, may be conducted after completion of the final operation of the conversion to acid form, or may be conducted at both timings.

### (Hydrogen Peroxide Treatment)

The method for producing the polymer H may have, after the conversion to acid form (after the water washing treatment 2 if conducted), a hydrogen peroxide treatment of bringing the polymer H into contact with hydrogen peroxide. By this treatment, impurities (e.g. organic substances other than the polymer H) contained in the polymer H can be decomposed.

In a case where the operation of the conversion to acid form is conducted several times, the hydrogen peroxide treatment may be conducted between the respective operations of the conversion to acid form or may be conducted after completion of the final operation of the conversion to acid form.

Hydrogen peroxide may be in the form of an aqueous solution or may be gaseous, and in view of handling efficiency, it is preferably in the form of an aqueous solution (aqueous hydrogen peroxide solution).

In a case where an aqueous hydrogen peroxide solution is used, the content of hydrogen peroxide relative to the total mass of the aqueous hydrogen peroxide solution is preferably 5 mass % or more, more preferably 10 mass % or more, and is preferably 30 mass % or less, more preferably 20 mass % or less.

The amount of hydrogen peroxide used relative to the amount (100 parts by mass) of the polymer H used is, in view of decomposition of the impurities, preferably 100 parts by mass or more, more preferably 200 parts by mass or more, and is preferably 1000 parts by mass or less, more preferably 500 parts by mass or less.

In a case where the aqueous hydrogen peroxide solution is used, the temperature of the aqueous hydrogen peroxide solution is, in view of decomposition of the impurities, preferably 40 °C or higher, more preferably 50 °C or higher, and with a view to suppressing elution of the polymer, preferably 120 °C or lower, more preferably 100 °C or lower.

The contact time (reaction time) of the polymer H and the hydrogen peroxide is, with a view to accelerating decomposition of the impurities, preferably 5 hours or longer, more preferably 8 hours or longer, and with a view to suppressing elution of the polymer, preferably 200 hours or shorter, more preferably 100 hours or shorter.

### (Water-Washing Treatment 3)

The method for producing the polymer H may have water-washing treatment 3 of washing with water the polymer H after the hydrogen peroxide treatment.

In the water-washing treatment 3, the amount of water used relative to the amount (100 parts by mass) of the polymer H used is, in view of washing efficiency, preferably 100 parts by mass or more, more preferably 200 parts by mass or more, and with a view to reducing the waste liquid, preferably 1000 parts by mass or less, more preferably 500 parts by mass or less.

In the water-washing treatment 3, the water temperature is, in view of washing efficiency, preferably 10 °C or higher, more preferably 20 °C or higher, and with a view to suppressing elution of the polymer, preferably 120 °C or lower, more preferably 100 °C or lower.

In the water-washing treatment 3, the washing time is, with a view to improving the washing efficiency, preferably 10 minutes or longer, more preferably 20 minutes or longer, and with a view to suppressing elution of the polymer, preferably 2 hours or shorter, more preferably 1 hour or shorter. The washing time refers to a washing time for each washing operation.

The water-washing treatment 3 may be conducted only once, or may be conducted several times. The number of the water-washing treatment 3 is, with a view to improving the washing efficiency, preferably two or more, more preferably three or more, and with a view to suppressing elution of the polymer, preferably 20 or less, more preferably 10 or less.

### (Separation Treatment)

The separation treatment is a treatment of separating, from the mixture obtained via the above treatments, a solid composition containing the polymer H and the first solvent.

Here, the polymer H has liquid absorbing property. Thus, the polymer H in the mixture is in a swollen state (for example in a gel state) as a result of absorbing a portion of the first solvent used for production of the polymer H.

In other words, the solid composition can be regarded as a polymer having the polymer H wetted with the first solvent (hereinafter also referred to as “wet polymer”).

The mixture contains the solid composition, and may further contain the first solvent.

The first solvent is preferably water.

The content of the first solvent in the mixture relative to the total mass of the mixture is preferably 40 mass % or more, more preferably 50 mass % or more, further preferably 55 mass % or more, and is preferably 95 mass % or less, more preferably 92 mass % or less, further preferably 90 mass % or less.

The content of the first solvent in the mixture includes not only the content of the first solvent which swells the polymer H (that is, the first solvent in the solid composition) but also the content of the first solvent which is not used for swelling the polymer H.

The content of the solid composition in the mixture relative to the total mass of the mixture is preferably 5 mass % or more, more preferably 8 mass % or more, further preferably 10 mass % or more, and is preferably 65 mass % or less, more preferably 50 mass % or less, further preferably 45 mass % or less.

The content of the first solvent in the solid composition relative to the total mass of the solid composition is, in that subsequent formation into a solution be easily carried out, preferably 10 mass % or more, more preferably 20 mass % or more, further preferably 30 mass % or more, and with a view to shortening the drying time, preferably 95 mass % or less, more preferably 90 mass % or less, further preferably 85 mass % or less.

The content of the polymer H in the solid composition relative to the total mass of the solid composition is, with a view to shortening the drying time, preferably 5 mass % or more, more preferably 10 mass % or more, further preferably 15 mass % or more, and in that subsequent formation into a solution be easily carried out, preferably 90 mass % or less, more preferably 80 mass % or less, further preferably 70 mass % or less.

A method of separating the solid composition from the mixture is not particularly limited, and a method such as filtration may be mentioned.

### <Step 2>

Step 2 is a step of subjecting the solid composition obtained in step 1 to a treatment of removing the first solvent to obtain a composition having a content of the first solvent relative to the total mass of the polymer H of 2 to 200 mass %. That is, step 2 is a step in which at least a portion of the first solvent in the solid composition that is a wet polymer is removed to obtain a composition that is a wet polymer having a content of the first solvent lower than that in the wet polymer obtained in step 1.

A method of removing the first solvent from the solid composition may be a drying treatment of drying the solid composition.

The drying treatment may be conducted by natural drying, heat drying, air drying or a combination thereof.

The drying temperature is, with a view to improving the drying efficiency, preferably 20 °C or higher, more preferably 30 °C or higher, and with a view to easily controlling the amount of the first solvent removed from the solid composition, preferably 120 °C or lower, more preferably 100 °C or lower.

The drying time is, in view of prevention of uneven drying, preferably 10 minutes or longer, more preferably 20 minutes or longer, and in view of the drying efficiency, preferably 72 hours or shorter, more preferably 48 hours or shorter.

The composition obtained in step 2 contains the polymer H and the first solvent.

In the composition obtained in step 2, the content of the first solvent relative to the total mass of the polymer H is 2 to 200 mass %.

In the composition obtained in step 2, the content of the first solvent relative to the total mass of the polymer H is, with a view to further reducing the particle size of the polymer H contained in the liquid composition to be obtained in step 3, preferably 3 mass % or more, more preferably 5 mass % or more, and in view of more excellent production consistency of the liquid composition to be obtained in step 3, preferably 180 mass % or less, more preferably 150 mass % or less.

The treatment of removing the first solvent in step 2 is conducted so that the content of the first solvent in the composition obtained in step 2, relative to the content of the first solvent in the solid composition obtained in step 1, is preferably 2 mass % or more, more preferably 3 mass % or more. When the content is 2 mass % or more, the particle size of the polymer H contained in the liquid composition to be obtained in step 3 can further be reduced.

The treatment of removing the first solvent in step 2 is conducted so that the content of the first solvent in the composition obtained in step 2, relative to the content of the first solvent in the solid composition obtained in step 1, is preferably 95 mass % or less, more preferably 93 mass % or less. When the content is 95 mass % or less, the liquid composition to be obtained in step 3 will be more excellent in production consistency.

### <Step 3>

Step 3 is a step of mixing the composition obtained in step 2 with a second solvent containing water and an alcohol to obtain a liquid composition containing the polymer H.

The second solvent contains water and an alcohol.

Specific examples of the alcohol include methanol, ethanol, 1-propanol, 2-propanol, 1-butanol, 2-methyl-1-propanol, 2-butanol, 2-methyl-2-propanol, 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol, and 3,3,4,4,5,5,6,6,7,7,8,8,8-tridecafluoro-1-octanol. Among them, in view of more excellent effects of the present invention, preferred are ethanol, 1-propanol, 1-butanol and 2-propanol, more preferred are ethanol and 1-propanol.

The alcohol may be used alone or in combination of two or more.

In the second solvent, the content of the alcohol is preferably 20 mass % or more, more preferably 25 mass % or more, further preferably 30 mass % or more, and is preferably 90 mass % or less, more preferably 80 mass % or less, further preferably 75 mass % or less.

In the second solvent, the content of the water is preferably 10 mass % or more, more preferably 20 mass % or more, further preferably 25 mass % or more, and is preferably 80 mass % or less, more preferably 75 mass % or less, further preferably 70 mass % or less.

The amount of the second solvent used relative to the amount (100 parts by mass) of the composition used is preferably 8 parts by mass or more, more preferably 10 parts by mass or more, and is preferably 40 parts by mass or less, more preferably 30 parts by mass or less.

The temperature of the second solvent is preferably 80 °C or higher, more preferably 100 °C or higher, and is preferably 180 °C or lower, more preferably 130 °C or lower.

The mixing time of the composition with the second solvent is preferably 1 hour or longer, more preferably 2 hours or longer, and is preferably 48 hours or shorter, more preferably 24 hours or shorter.

An example of the mixing method may be a method of adding a shear force e.g. by stirring the liquid mixture of the second solvent and the polymer H.

The entire second solvent may be added to the polymer H all at once and the mixture is stirred, or the second solvent may be added in divided portions to the polymer H and stirring is conducted between the adding operations.

Otherwise, a portion of the alcohol and a portion of the water may be added to the polymer H, the resulting liquid mixture is stirred, and the rest of the second solvent is added and the mixture is stirred again.

Further, only the alcohol may be added to the polymer H and the resulting mixture is stirred, and then only the water is added and the mixture is stirred again.

In a case where the shearing force is applied, the shear rate is preferably 10 to 1000 s⁻¹, more preferably 50 to 600 s⁻¹.

Step 3 may have a filtration treatment of subjecting the liquid composition to filtration. By this treatment, included foresing materials and undissolved polymer may be removed.

A method of the filtration treatment may be filtration thorough a filter (for example a PTFE filter).

At the filtration treatment, the temperature of the liquid composition is preferably 10 °C or higher, more preferably 20 °C or higher, and is preferably 100 °C or lower, more preferably 90 °C or lower.

The pressure in the filtration treatment is, with a view to shortening the filtration time, preferably 0.001 MPa or more, and with a view to suppressing breakthrough, preferably 0.2 MPa or less, more preferably 0.1 MPa or less. The filtration treatment may be a treatment without involving pressurization.

The liquid composition thus obtained contains the polymer H and the second solvent.

The polymer H in the liquid composition is dispersed in the second solvent preferably in the form of particles containing the polymer H.

The average secondary particle size of the particles containing the polymer H is preferably 1 nm or more, more preferably 5 nm or more, further preferably 10 nm or more, and is preferably less than 400 nm, more preferably 300 nm or less.

The average secondary particle size of the particles containing the polymer H is measured by the method in EXAMPLES to be described below.

The content of the polymer H relative to the total mass of the liquid composition is preferably 5 mass % or more, more preferably 10 mass % or more, and is preferably 50 mass % or less, more preferably 40 mass % or less.

The content of the second solvent relative to the total mass of the liquid composition is preferably 50 mass % or more, more preferably 60 mass % or more, and is preferably 95 mass % or less, more preferably 90 mass % or less.

The liquid composition obtained in the present production method is used preferably for production of a polymer electrolyte membrane.

Further, the liquid composition obtained in the present production method is also used preferably for production of at least one of the catalyst layer of the anode and the catalyst layer of the cathode of a membrane electrode assembly to be described below.

### [Polymer Electrolyte Membrane]

The polymer electrolyte membrane of the present invention (hereinafter also referred to as “the present electrolyte membrane”) is formed by using the liquid composition obtained by the above method and contains the polymer H, and with a view to further increasing the strength of the present electrolyte membrane, preferably further contains a reinforcing member. With a view to further improving the durability, the present electrolyte membrane may contain at least one type of an atom selected from the group consisting of cerium and manganese.

The polymer H contained in the present electrolyte membrane is as described above.

Specific examples of the reinforcing member include a porous body, a fiber, a woven fabric and a non-woven fabric.

The material of the reinforcing member is preferably a polytetrafluoroethylene, a tetrafluoroethylene/hexafluoropropylene copolymer, a tetrafluoroethylene/perfluoro (alkyl vinyl ether) copolymer, a polyethylene, a polypropylene, or a polyphenylene sulfide, and in view of excellent chemical durability, more preferably a polytetrafluoroethylene.

The pore size of the porous body is preferably 10 to 2000 nm, more preferably 50 to 1800 nm.

The particles containing the polymer H, contained in the liquid composition obtained by the above method, have a small particle size. Accordingly, when the porous body is used as the reinforcing member, the particles containing the polymer H are likely to infiltrate into the pores of the porous body. Thus, generation of unfilled pores in the present electrolyte membrane can be suppressed.

Cerium and manganese can decompose hydrogen peroxide, a material that causes deterioration of the present electrolyte membrane. Cerium and manganese are present in the present electrolyte membrane preferably in the form of ions.

The method for producing the present electrolyte membrane is not particularly limited so long as the liquid composition obtained by the above method is used. For example, the present electrolyte membrane can be formed by a method (casting method) of applying the liquid composition to the surface of a substrate film or a catalyst layer, followed by drying. In a case where the present electrolyte membrane further has the reinforcing member, the present electrolyte membrane can be formed by a method of dipping the reinforcing member in the liquid composition, followed by drying.

### [Membrane Electrode Assembly]

The membrane electrode assembly of the present invention (hereinafter also referred to as “the present membrane electrode assembly”) has an anode having a catalyst layer, a cathode having a catalyst layer and an electrolyte membrane disposed between the anode and the cathode.

The present membrane electrode assembly is used suitably for a polymer electrolyte fuel cell.

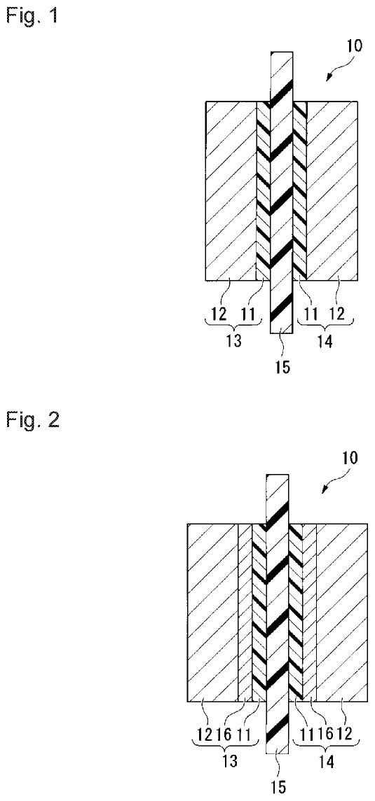

FIG. 1 is a cross sectional view illustrating an example of the present membrane electrode assembly. A membrane electrode assembly 10 comprises an anode 13 having a catalyst layer 11 and a gas diffusion layer 12, a cathode 14 having a catalyst layer 11 and a gas diffusion layer 12, and a polymer electrolyte membrane 15 disposed between the anode 13 and the cathode 14 in contact with the catalyst layers 11.

The catalyst layer 11 is a layer containing a catalyst and a polymer having an ion exchange group.

Specific examples of the catalyst include a supported catalyst having platinum or a platinum alloy supported on a carbon support.

Specific examples of the polymer having an ion exchange group include the polymer H, and a perfluoropolymer having an ion exchange group, other than the polymer H.

The gas diffusion layer 12 has a function to diffuse gas uniformly in the catalyst layer 11 and a function as a current collector.

The gas diffusion layer 12 may, for example, be a carbon paper, a carbon cloth or a carbon felt.

The gas diffusion layer 12 is preferably made water-repellent e.g. with polytetrafluoroethylene.

The polymer electrolyte membrane 15 is preferably the above-described present electrolyte membrane.

As shown in FIG. 2, a membrane electrode assembly 10 may have a carbon layer 16 between each catalyst layer 11 and each gas diffusion layer 12.

By disposing the carbon layer 16, the gas diffusivity of the surface of the catalyst layer 11 improves, and the power generation performance of a polymer electrolyte fuel cell greatly improves.

The carbon layer 16 is a layer containing carbon and a nonionic fluorinated polymer.

The carbon may, for example, be carbon particles or a carbon fiber, and is preferably a carbon nanofiber having a fiber diameter of 1 to 1000 nm and a fiber length of 1000 μm or less.

The nonionic fluorinated polymer may, for example, be polytetrafluoroethylene.

In a case where the membrane electrode assembly 10 has no carbon layer 16, the membrane electrode assembly 10 is produced, for example, by the following method.
A method of forming the catalyst layers 11 on the polymer electrolyte membrane 15 to form a membrane catalyst layer assembly, which is sandwiched between the gas diffusion layers 12.
A method of forming the catalyst layer 11 on the gas diffusion layer 12 to form electrodes (the anode 13 and the cathode 14), and sandwiching the polymer electrolyte membrane 15 between the electrodes.

In a case where the membrane electrode assembly 10 has the carbon layer 16, the membrane electrode assembly 10 is produced, for example, by the following method.
A method of applying a dispersion containing the carbon and the nonionic fluorinated polymer to a substrate film, followed by drying to form the carbon layer 16, forming the catalyst layer 11 on the carbon layer, bonding such catalyst layers 11 and the polymer electrolyte membrane 15, separating the substrate films to form a membrane catalyst layer assembly having the carbon layers 16, and sandwiching the membrane catalyst layer assembly between the gas diffusion layers 12.
A method of applying a dispersion containing the carbon and the nonionic fluorinated polymer to the gas diffusion layer 12, followed by drying to form the carbon layer 16, and sandwiching a membrane catalyst layer assembly having the catalyst layers 11 formed on the polymer electrolyte membrane 15 between the gas diffusion layers 12 each having the carbon layer 16.

The method of forming the catalyst layer 11 may, for example, be the following method.
A method of applying a catalyst layer-forming coating liquid to the polymer electrolyte membrane 15, the gas diffusion layer 12, or the carbon layer 16, followed by drying.
A method of applying a catalyst layer-forming coating liquid to a substrate film, followed by drying to form the catalyst layer 11, and transferring the catalyst layer 11 onto the polymer electrolyte membrane 15.

The catalyst layer-forming coating liquid is a liquid having the polymer having an ion exchange group and he catalyst dispersed in a dispersion medium. The catalyst layer-forming coating liquid may be prepared, for example, by mixing the liquid composition containing the polymer having an ion exchange group, and a dispersion of the catalyst. With a view to further improving the durability of the catalyst layer 11, the catalyst layer-forming coating liquid may contain at least one metal selected from the group consisting of cerium and manganese, or a metal compound or a metal ion thereof.

The catalyst layer-forming coating liquid may be a liquid prepared by using the liquid composition obtained by the above-described present production method.

### [Polymer Electrolyte Fuel Cell]

The polymer electrolyte fuel cell of the present invention (hereinafter also referred to as “the present fuel cell”) has the above-described present membrane electrode assembly.

The present fuel cell may be one having a separator having a groove to be a gas flow path formed thereon, on both sides of the membrane electrode assembly. The separator may, for example, be a separator made of a conductive material, such as a metal separator, a carbon separator or a separator made of a material obtained by mixing graphite and a resin.

In the present fuel cell, electricity is generated by supplying an oxygen-containing gas to the cathode and a hydrogen-containing gas to the anode. The present membrane electrode assembly is also applicable to a methanol fuel cell in which electricity is generated by supplying methanol to the anode.

### EXAMPLES

Now the present invention will be described in detail with reference to Examples. Ex. 1 and 3 to 5 are Examples of the present invention, and Ex. 2 and 6 to 7 are Comparative Examples. However, it should be understood that the present invention is by no means restricted to such specific Examples.

In the following, a fluorinated polymer having a fluorosulfonyl group will generically be referred to as “polymer F”, and a fluorinated polymer obtained by converting the fluorosulfonyl group of the polymer F to a sulfonic acid group will generically be referred to as “polymer H”.

### ABBREVIATION

TFE: CF₂═CF₂
monomer (m1): CF₂═CFOCF₂CF(CF₃) OCF₂CF₂SO₂F
monomer (m2): a monomer represented by the following formula (m2)
monomer (m3): a monomer represented by the following formula (m3)

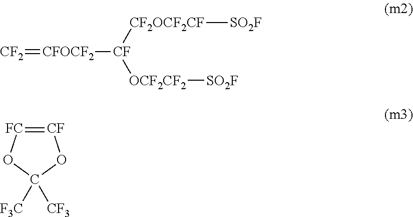

### [Composition]

The composition of the structural units in the polymer F was obtained by 19F-NMR.

The results are shown in the following Table.

### [Ion Exchange Capacity]

The ion exchange capacity (meq/g dry resin) of the polymer F was calculated from the chemical composition of the structural units of the polymer F obtained by the above method. The results are shown in the following Table.

The ion exchange capacity of the polymer H is the same as the ion exchange capacity of the polymer F since the polymer H has the same composition as the polymer F.

### [TQ Value]

The polymer F was vacuum dried at 240 °C for 16 hours. The vacuum-dried polymer F was melt-extruded under an extrusion pressure of 2.94 MPa (gauge pressure) at varied temperatures using a flow tester (manufactured by Shimadzu Corporation, CFT-500D) equipped with a nobble having a length of 1 mm and an inner diameter of 1 mm. The temperature (TQ value) at which the extrusion amount of the polymer F reached 100 mm³/second was obtained. The results are shown in the following Table.

### [Content of Water Relative to Polymer H in Composition Obtained in Step 2]

The content (mass %) of the water (first solvent) relative to the polymer H in each composition obtained in step 2 to be described below, was obtained in accordance with the following formula by heating 1 g of the composition obtained in step 2 at 160 °C for 40 minutes and then weighing the mass of the residue. The results are shown in the following Table.

Content (mass %) of water relative to polymer H in composition=100×[{mass of composition (that is 1 g)}−{mass (g) of residue]/[mass (g) of residue (g)}

### [Content of Water in Composition Obtained in Step 2 Relative to Content of Water in Soldi Composition Obtained in Step 1]

The content A (g) of the water (first solvent) in the solid composition obtained in step 1 to be described below is obtained in accordance with the following formula by heating 1 g of the solid composition obtained in step 1 at 160 °C for 40 minutes and weighing the mass of the residue.

Content A (g)={mass of solid composition (that is 1 g)}-{mass (g) of residue} Further, the content B (g) of the water (first solvent) in the composition obtained in step 2 to be described below was obtained in accordance with the following formula by heating 1 g of the composition obtained in step 2 at 160 °C for 40 minutes and weighing the mass of the residue.

Content B (g) {mass of composition (that is 1 g)}−{mass (g) of residue}

The ratio (mass %) of the content B to the content A as obtained above was calculated, and the obtained value was taken as the content of the water in the composition obtained in step 2 relative to the content of the water in the solid composition obtained in step 1. The results are shown in the following Table.

### [Evaluation of Production Consistency]

Three liquid compositions with different batches were prepared by the method described in Ex. 1. The solids concentration of the liquid composition was compared among the batches, and the production consistency was evaluated according to the following standards.

In the same manner as the method of evaluation of production consistency in Ex. 1 except that the liquid composition obtained in each Ex. was used, production consistency was evaluated in other Ex.

The results are shown in the following Table. In the Table, “-” means that no evaluation was conducted.

### (Method for Calculating Solids Concentration of Liquid Composition)

The solids concentration of the liquid composition was obtained in accordance with the following formula by hating 1 g of the liquid composition at 160 °C for 3 hours and weighing the mass of the residue.

Solids concentration (mass %)=100×[residue (g) of liquid composition]/[mass of liquid composition (that is 1 g)]

### (Evaluation Standards)

◯ (good): maximum difference in solids concentration among batches of less than 2 mass %.
x (bad): maximum difference in solids concentration among batches of 2 mass % or more.

### [Evaluation of Particle Size]

The liquid composition obtained in each Ex. was diluted with ultrapure water to a solids concentration of 0.2 mass % and left at rest for 16 hours to prepare a sample.

Using a fiber-optic dynamic light scattering photometer (manufactured by Otsuka Electronics Co., Ltd., FDLS-3000), the scattering intensity of the sample was measured under the following conditions: temperature 25 °C, sampling time 100 μs, number of channels 1024, and accumulation count 100. The average secondary particle size of the polymer H (particles containing the polymer H) in the liquid composition was calculated by cumulant analysis of the obtained autocorrelation function. Based on the obtained average secondary particle size values, the particle size of the polymer H was evaluated according to the following standards.

The results are shown in the following Table. In Table, “-” indicates that no evaluation was conducted.

(Evaluation standards)
◯ (good): average secondary particle size being less than 400 nm.
x (bad): average secondary particle size being 400 nm or more.

### [Ex. 1]

Polymer F-1A having a unit based on the monomer (m1) and a unit based on TFE was obtained with reference to the method until prior to the hydrolysis treatment, as described in JP-A-2015-99772 at paragraph 0200.

The polymer F-1A was charged together with dry ice to a hammer crusher with a screen opening of 3 mm and pulverized under cooling.

### <Step 1>

In an aqueous alkali solution (an aqueous solution containing 64 g of methanol, 96 g of potassium hydroxide and 160 g of water) heated to 80 °C, 100 g of the pulverized polymer F-1A was hydrolyzed for 24 hours (hydrolysis treatment). Then, an operation of washing 105 g of the polymer after the hydrolysis treatment with 230 g of water at 30 °C for 1 hour was repeated three times (water washing treatment 1).

An operation of reacting 105 g of the polymer after the water washing treatment with 300 g of an aqueous acidic solution (an aqueous sulfuric acid solution at a sulfuric acid concentration of 8 mass %) at 60 °C for 30 minutes was repeated 5 times (conversion to acid form). An operation of washing 99 g of the polymer after the conversion to acid form with 300 g of water at 60 °C for 1 hour was repeated three times (water washing treatment 2).

Then, 99 g of the polymer after the water washing treatment and an aqueous hydrogen peroxide solution (hydrogen peroxide concentration of 13 mass %) at 55 °C were reacted for 20 hours (hydrogen peroxide treatment). An operation of washing 99 g of the polymer after the hydrogen peroxide treatment with 230 g of water at 30 °C for 1 hour was repeated three times (water-washing treatment 3).

An operation of reacting 99 g of the polymer after the water washing treatment and 300 g of an aqueous acidic solution (an aqueous sulfuric acid solution at a sulfuric acid concentration of 8 mass %) at 60 °C for 30 minutes was repeated 6 times (conversion to acid form). Then, an operation of washing 99 g of the polymer after the conversion to acid form with 300 g of water at 60 °C for 1 hour was repeated 11 times (water washing treatment 2). By these operations, mixture 1 containing water (the first solvent) and polymer H-1A in which the fluorosulfonyl group of the polymer F-1A was converted to a sulfonic acid group was obtained. The content of the water in the mixture 1 was 78 mass % relative to the total mass of the mixture 1.

From the mixture 1, solid composition 1 containing the polymer H-1A and the water was separated by filtration using a filter (material: PFA, opening: 313 μm, product name “Fluororesin mesh”, manufactured by tantore Corporation) (separation treatment).

The solid composition 1 was a wet polymer in which the polymer H-1A was swollen with water.

The water used for the above respective treatments had a specific resistance of 18 MΩ·cm and a TOC (total organic carbon) of 50 mass ppb.

<Step 2>

99 g of the solid composition 1 obtained in step 1 was dried by flowing nitrogen gas (1 L/min) at 40 °C for 30 minutes to obtain composition 1 containing the polymer H-1A.

### <Step 3>

The composition 1 weighed so that the mass of the polymer H-1A became 20 g, 40 g of ethanol and 40 g of water (including the water in the composition 1) were put in a stainless steel autoclave having an internal capacity of 200 mL and stirred by a helical ribbon impeller at 105 °C at a rotational speed of 250 rpm for 6 hours. The dispersion after stirring was cooled to room temperature (25 °C) and subjected to filtration through a PTFE filter (pore size 3 μm) under a pressure of 0.01 MPa to obtain liquid composition 1.

### [Ex. 2]

Liquid composition 2 was obtained in the same manner as in Ex. 1 except that the drying conditions for the solid composition 1 in step 2 were changed to 90 °C for 10 hours to obtain composition 2, and the composition 2 was used instead of the composition 1.

### [Ex. 3]

In accordance with the method disclosed in Examples of Japanese Patent Application No. 6631630, polymer F-2A having a unit based on the monomer (m2), a unit based on the monomer (m3) and a unit based on TFE was obtained.

The polymer F-2A was charged together with dry ice to a hammer crasher with a screen opening of 2 mm and pulverized under cooling.

### <Step 1>

In an aqueous alkali solution (an aqueous solution containing 80 g of methanol, 120 g of potassium hydroxide and 200 g of water) heated to 80 °C, 100 g of the pulverized polymer F-2A was hydrolyzed for 24 hours (hydrolysis treatment). Then, an operation of washing 105 g of the polymer after the hydrolysis treatment with 300 g of water at 65 °C for 30 minutes was repeated 20 times (water washing treatment 1).

Then, an operation of reacting 105 g of the polymer after the water washing treatment and 300 g of an aqueous acidic solution (aqueous sulfuric acid solution having a sulfuric acid concentration of 15 mass %) at 65 °C for 30 minutes was repeated 10 times (conversion to acid form). Thereafter, an operation of washing 99 g of the polymer after the conversion to acid form with 400 g of water at 65 °C for 30 minutes was repeated 14 times (water washing treatment 2). The polymer after the water washing treatment was dried for 8 hours.

99 g of the polymer after drying and 450 g of an aqueous hydrogen peroxide solution (hydrogen peroxide cpmcemtratopm 10 mass %) at 80 °C were reacted for 16 hours (hydrogen peroxide treatment). Then, an operation of washing 99 g of the polymer after the hydrogen peroxide treatment with 300 g of water at 65 °C for 30 minutes was repeated 5 times (water-washing treatment 3). By these treatments, mixture 2 containing water (the first solvent) and polymer H-2A in which the fluorosulfonyl group of the polymer F-2A was converted to a sulfonic acid group was obtained. The content of the water in the mixture 2 relative to the total mass of the mixture 2 was 69 mass %.

Then, from the mixture 2, solid composition 2 containing the polymer H-2A and water was separated by filtration using a filter (material: PFA, opening: 313 μm, product name “Fluororesin mesh”, manufactured by tantore Corporation) (separation treatment). The solid composition 2 was a wet polymer in which the polymer H-2A was swollen with the water.

The water used in the respective treatments had a specific resistance of 18 MΩ·cm, and a TOC (total organic carbon) of 50 mass ppb.

<Step 2>99 g of the solid composition 2 obtained in step 1 was dried by flowing nitrogen gas (1 L/min) at 25 °C for 30 minutes to obtain composition 3 containing the polymer H-2A.

### <Step 3>

The composition 3 weighed so that the mass of the polymer H-2A became 14 g, 43 g of 1-propanol and 43 g of water (including the water in the composition 2) were put in a stainless steel autoclave having an internal capacity of 200 mL and stirred by a helical ribbon impeller at 115 °C at a rotational speed of 300 rpm for 6 hours. The dispersion after stirring was cooled to room temperature (25 °C) and subjected to filtration through a PTFE filter (opening: 3 μm) under a pressure of 0.01 MPa to obtain liquid composition 3.

### [Ex. 4]

Liquid composition 4 was obtained in the same manner as in Example 3 except that the drying conditions for the solid composition 2 were changed to 25 °C for 2 hours in step 2 to obtain composition 4, and the obtained composition 4 was used instead of the composition 3.

### [Ex. 5]

Liquid composition 5 was obtained in the same manner as in Example 3 except that the drying conditions for the solid composition 2 were changed to 25 °C for 6 hours in step 2 to obtain composition 5, and the obtained composition 5 was used instead of the composition 3.

### [Ex. 6]

Liquid composition 6 was obtained in the same manner as in Example 3 except that the drying conditions for the solid composition 2 were changed to 80 °C for 16 hours in step 2 to obtain composition 6, and the obtained composition 6 was used instead of the composition 3.

### [Ex. 7]

Liquid composition 7 was obtained in the same manner as in Example 3 except that the drying conditions for the solid composition 2 were changed to 25 °C for 5 minutes in step 2 to obtain composition 7, and the obtained composition 7 was used instead of the composition 3.

TABLE 1

| | Constituting | | | | Ion exchange | TQ |
|---|---|---|---|---|---|---|
| Type of | units (mol%) | | | | capacity | value |
| polymer F | m1 | m2 | m3 | TFE | (meq/g dry resin) | (°C) |
| F-1A | 73 | — | — | 27 | 1.4 | 220 |
| F-2A | — | 24 | 65 | 11 | 1.5 | 215 |

TABLE 2

| | | | Composition | | | | | |
|---|---|---|---|---|---|---|---|---|
| | | | obtained in step 2 | | | | | |
| | | | | | Content of | | | |
| | | | | | water in | | | |
| | | | | | composition | | | |
| | | | | | obtained | | | |
| | | | | | in step | | | |
| | | | | | 2 relative | | | |
| | | | | | to content | | | |
| | | | | Content | of water | | | |
| | | Solid | | of water | in solid | Liquid | | |
| | | composition | | relative to | composition | composition | | |
| | Type of | obtained | | polymer H in | obtained | obtained | Evaluation results | |
| | polymer | in step 1 | | composition | in step 1 | in step 3 | Particle | Production |
| | H | Type | Type | (mass %) | (mass %) | Type | size | consistency |
| Ex. 1 | H-1A | 1 | 1 | 75 | 55 | 1 | O | O |
| Ex. 2 | H-1A | 1 | 2 | 1 | 1 | 2 | X | — |
| Ex. 3 | H-2A | 2 | 3 | 180 | 93 | 3 | O | O |
| Ex. 4 | H-2A | 2 | 4 | 64 | 57 | 4 | O | O |
| Ex. 5 | H-2A | 2 | 5 | 4 | 6 | 5 | O | O |
| Ex. 6 | H-2A | 2 | 6 | 1 | 1 | 6 | X | — |
| Ex. 7 | H-2A | 2 | 7 | 220 | 100 | 7 | — | X |

It was confirmed from Table 2 that according to the production method of the present invention, it is possible to provide a liquid composition containing a polymer H with a small particle size, and being excellent in production consistency (Ex. 1, 3 to 5).

This application is a continuation of PCT Application No. PCT/JP2024/041602, filed on Nov. 25, 2024, which is based upon and claims the benefit of priority from Japanese Patent Application No. 2023-205520 filed on Dec. 5, 2023. The contents of those applications are incorporated herein by reference in their entireties.

### REFERENCE SYMBOLS

10: membrane electrode assembly
11: catalyst layer
12: gas diffusion layer
13: anode
14: cathode
15: polymer electrolyte membrane
16: carbon layer

What is claimed is:

1. A method for producing a liquid composition, which comprises:
separating, from a mixture obtained by subjecting a fluorinated polymer F having a group convertible to an ion exchange group to a hydrolysis treatment and conversion to acid form to convert the group convertible to an ion exchange group into an acid-form ion exchange group in a first solvent, a solid composition containing a fluorinated polymer H having an ion exchange group and the first solvent,
conducting a treatment to remove the first solvent from the solid composition to obtain a composition having a content of the first solvent relative to the total mass of the fluorinated polymer H of 2 to 200 mass %, and
mixing the composition with a second solvent containing water and an alcohol to obtain a liquid composition containing the fluorinated polymer H having an ion exchange group.

2. The method for producing the liquid composition according to claim 1, wherein the fluorinated polymer F has a unit based on a compound represented by formula (1):
CF₂═CF-L-(A) n Formula (1)
in formula (1), L is a (n+1)-valent perfluorohydrocarbon group which may contain an etheric oxygen atom, A is a group convertible to a sulfonic acid functional group, and n is 1 or 2.

3. The method for producing the liquid composition according to claim 1, wherein the fluorinated polymer H has an ion exchange capacity of 0.8 to 3.0 meq/g dry resin.

4. The method for producing the liquid composition according to claim 1, wherein the alcohol contains at least one member selected from the group consisting of ethanol, 1-propanol, 1-butanol and 2-propanol.

5. The method for producing the liquid composition according to claim 1, wherein the liquid composition is used for production of a polymer electrolyte membrane.

6. The method for producing the liquid composition according to claim 1, wherein the liquid composition is used for production of at least one of a catalyst layer of an anode and a catalyst layer of a cathode in a membrane electrode assembly comprising an anode having a catalyst layer, a cathode having a catalyst layer, and a polymer electrolyte membrane disposed between the anode and the cathode.

7. The method for producing the liquid composition according to claim 1, wherein the content of the second solvent is 50 mass % or more and 95 mass % or less relative to the total mass of the liquid composition.

8. The method for producing the liquid composition according to claim 1, wherein the fluorinated polymer H is dispersed in the second solvent in the form of particles, and the particles have an average secondary particle size of 1 nm or more and less than 400 nm.
